(19) United States
(12) Patent Application Publication
(10) Pub. No.: US 2014/0033095 A1
(43) Pub. Date: Jan. 30, 2014

(54) APPARATUS AND METHOD FOR SETTING ICONS

(71) Applicant: FUJITSU LIMITED, Kawasaki-shi (JP)

(72) Inventors: Takahiro KOBA, Kawasaki (JP); Itaru HIRAKI, Yokohama (JP)

(21) Appl. No.: 13/907,876

(22) Filed: Jun. 1, 2013

(30) Foreign Application Priority Data
Jul. 30, 2012 (JP) 2012-168340

(51) Int. Cl. G06F 3/0481

(52) U.S. Cl. CPC G06F 3/04817
USPC 715/765

(57) ABSTRACT

An apparatus displays, via a display device, an icon associated with an executable function on a display screen based on display settings including a selection recognition zone associated with the icon. The apparatus stores icon setting information that associates the icon, an area, and change information for changing the display settings of the icon. The apparatus determine that the icon is selected when the selection recognition zone is specified on the display screen. Then, the apparatus acquires position information of the apparatus, and changes the display settings of the icon based on the change information of the icon setting information when the position of the apparatus is within the area registered in the icon setting information.

### CROSS-REFERENCE TO RELATED APPLICATION

This application is based upon and claims the benefit of priority of the prior Japanese Patent Application No. 2012-168340, filed on Jul. 30, 2012, the entire contents of which are incorporated herein by reference.

### FIELD

The embodiments discussed herein are related to an apparatus and method for setting icons.

### BACKGROUND

Nowadays devices equipped with touch panels are widely used, such as personal computers (PCs), tablet PCs, and smartphones. Such a device displays icons associated with applications, for example, on a display screen of the touch panel, so that the user selects an icon to execute a function such as startup of an application.

In relation to this, there are conventional techniques for controlling icon display on an input device on which operation input is performed through operation of selection icons on a monitoring control touch panel. There are also techniques relating to television receivers with interactive operation features.

Japanese Laid-open Patent Publication Nos. 9-54657 and 4-157990 are examples of related art.

### SUMMARY

According to an aspect of the invention, an apparatus includes a display device configured to display an icon associated with an executable function on a display screen based on display settings including a selection recognition zone associated with the icon. The apparatus stores icon setting information that associates the icon, an area, and change information for changing the display settings of the icon. The apparatus determines that the icon is selected when the selection recognition zone is specified on the display screen. Then the apparatus acquires position information of the information processing apparatus, and changes the display settings of the icon based on the change information of the icon setting information when the position of the information processing apparatus is within the area registered in the icon setting information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1D are diagrams illustrating exemplary display screens of an information processing apparatus, according to an embodiment;

FIGS. 2A to 2D are diagrams illustrating an example of display settings of icons, according to an embodiment;

FIGS. 3A to 3C are diagrams each illustrating an example of display settings of icons on a display screen of a touch panel, according to an embodiment;

FIG. 4 is a diagram illustrating an example of a functional configuration of an information processing apparatus, according to an embodiment;

FIG. 5 is a diagram illustrating an example of setting information, according to a first embodiment;

FIG. 6 is a diagram illustrating an example of an operational flowchart for changing icon display settings, according to a first embodiment;

FIG. 7 is a diagram illustrating an example of a selection history list for icons, according to an embodiment;

FIG. 8 is a diagram illustrating an example of range specifying information, according to an embodiment;

FIG. 9 is a diagram illustrating an example of an operational flowchart for generating setting information, according to an embodiment;

FIG. 10 is a diagram illustrating an example of aggregation information, according to an embodiment;

FIG. 11 is a diagram illustrating an example of setting information, according to a second embodiment;

FIG. 12 is a diagram illustrating an example of a schedule list, according to a second embodiment;

FIG. 13 is a diagram illustrating an example of schedule classification setting information, according to a second embodiment;

FIG. 14 is a diagram illustrating an example of an operational flowchart for changing icon display settings, according to a second embodiment;

FIG. 15 is a diagram illustrating an example of aggregation information, according to a second embodiment;

FIG. 16 is a diagram illustrating an example of an operational flowchart for generating setting information, according to a second embodiment; and

FIG. 17 is a diagram illustrating an example of a hardware configuration of an information processing apparatus, according to an embodiment.

### DESCRIPTION OF EMBODIMENTS

When multiple icons are displayed on a display screen, the user might inadvertently select an icon different from an intended one at the time of operation due to, for example, the icons being displayed close to each other. The embodiments discussed herein are intended to provide a technique for improving the operability of an information processing apparatus by use of position information.

Embodiments will now be described in detail with reference to the drawings. Throughout the drawings, corresponding elements are denoted by the same reference numerals and symbols. While the description below takes an information processing apparatus 1, such as a smartphone with a touch panel, as an example, the embodiments of the present disclosure are not limited thereto. For example, the embodiments may be applied to other kinds of device with a touch panel, such as personal computers, tablet PCs, PDAs, and electronic dictionaries. Alternatively, the embodiments are also applicable to equipment on which icons on a display device are selected via other kinds of input device, such as a mouse and a keyboard.

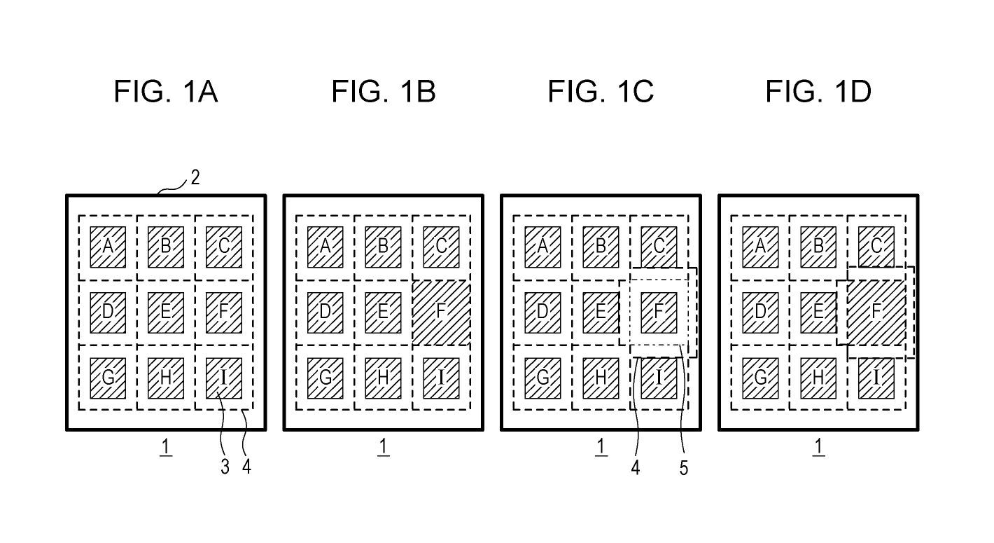

FIGS. 1A to 1D are diagrams illustrating exemplary display screens of an information processing apparatus, according to an embodiment, in which operability is improved by using position information. For example, FIG. 1A illustrates icons on the display screen of a touch panel 2 with normal display setting. FIG. 1B illustrates icons on the display screen of the touch panel 2 with display setting for enlarging the display size of icon F. FIG. 1C illustrates icons on the display screen of the touch panel 2 with display setting for enlarging a selection recognition area 4 of icon F. FIG. 1D illustrates icons on the display screen of the touch panel 2 with display setting for enlarging the display size of icon F and its selection recognition area 4.

Icon display settings refer to settings used for displaying an icon 3 on the display screen, including emphasis of the icon 3 (enlargement of its display size, for example) and enlargement of the selection recognition zone 4 of the icon 3, for example. The selection recognition zone 4 is an area which is defined on the display screen in relation to the icon 3 and accepts selection of the icon 3. For example, when a position inside the selection recognition zone 4 is specified via a touch panel or the like, it is recognized that the corresponding icon 3 has been selected, and the function associated with the icon 3 is executed. As represented in FIGS. 1A to 1D, display settings for an icon 3 include settings for enlarging the size of the icon 3 (FIG. 1B) and enlarging the selection recognition zone 4 of the icon 3 (FIG. 1C), for example. Display settings of an icon 3 may also be configured to enlarge both the size of the icon 3 and its selection recognition zone 4 (FIG. 1D).

In general, operation of an information processing apparatus 1 having a touch panel, such as a smartphone, is performed via the touch panel 2. For example, a function such as startup of an application is executed by touching an icon 3 associated with the function on the display screen of the touch panel 2. When multiple icons 3 are present closely spaced on the display screen of the touch panel 2 at the time of such an operation, the user may make a touching error when selecting an icon, such as accidentally touching a neighboring icon 3, causing the problem of poor operability.

In view of the problem, the embodiments discussed herein are intended to improve the operability of an information processing apparatus by use of position information. For example, it is conceivable that a user frequently uses browser, mail, and notebook functions at his/her office out of the functions included in the information processing apparatus 1, while the user often uses an application for reproducing music and moving pictures at home. In such a situation, the operability of the information processing apparatus 1 may be improved by changing the display settings of icons 3 which the user frequently uses at the current position of the information processing apparatus 1 so as to enlarge the display size of those icons 3 or their selection recognition zones 4, for example, so that the user may easily select the icons 3. Specifically, while the user is at the office, the display sizes of icons 3 for browser, mail, and notebook functions, which the user often uses at the office, are enlarged so that the user may easily find those icons 3, for example. Since icons 3 that are frequently used at the current position become easy to identify, touching errors such as accidentally pressing an icon 3 corresponding to an unintended application are kept from occurring.

It is also possible to enlarge the selection recognition zone 4 of an icon 3. For example, when the user is at home, the selection recognition zone 4 of the icon 3 for the application for playing music and moving pictures, which the user frequently uses at home, is enlarged so that the user may easily select the icon 3 of that application. With enlargement of the selection recognition zone 4 of icons 3, the user may select the desired icon 3 even if the user accidentally taps a position away from the icon 3 when selecting the frequently used icon 3. Thus, touching errors may be kept from occurring. In another embodiment, in order to further facilitate selection of a frequently used icon 3, both the display size of the icon 3 and the selection recognition zone 4 associated with the icon 3 may be enlarged.

As described above, by changing display settings of icons 3 that are frequently used at the current position of the information processing apparatus 1 so as to make those icons easier to select, selection errors by the user may be reduced and the operability of the information processing apparatus 1 may be improved.

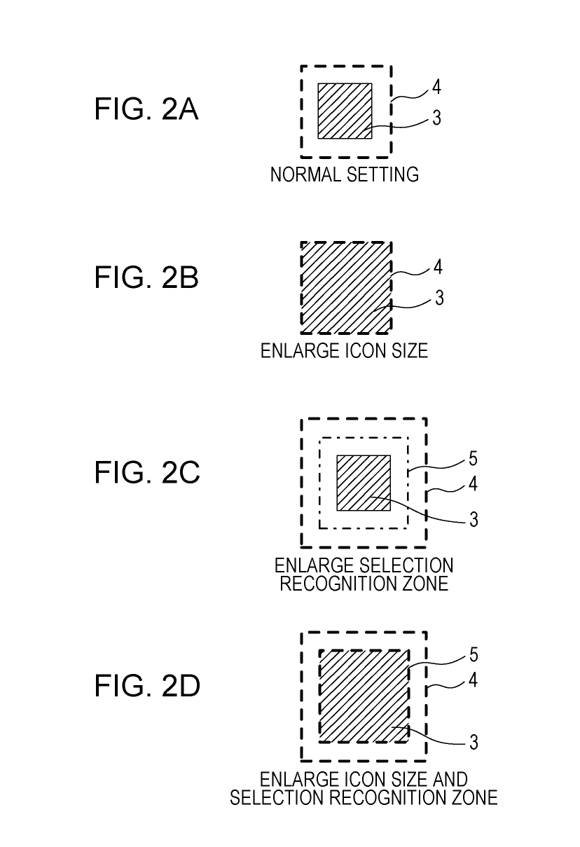

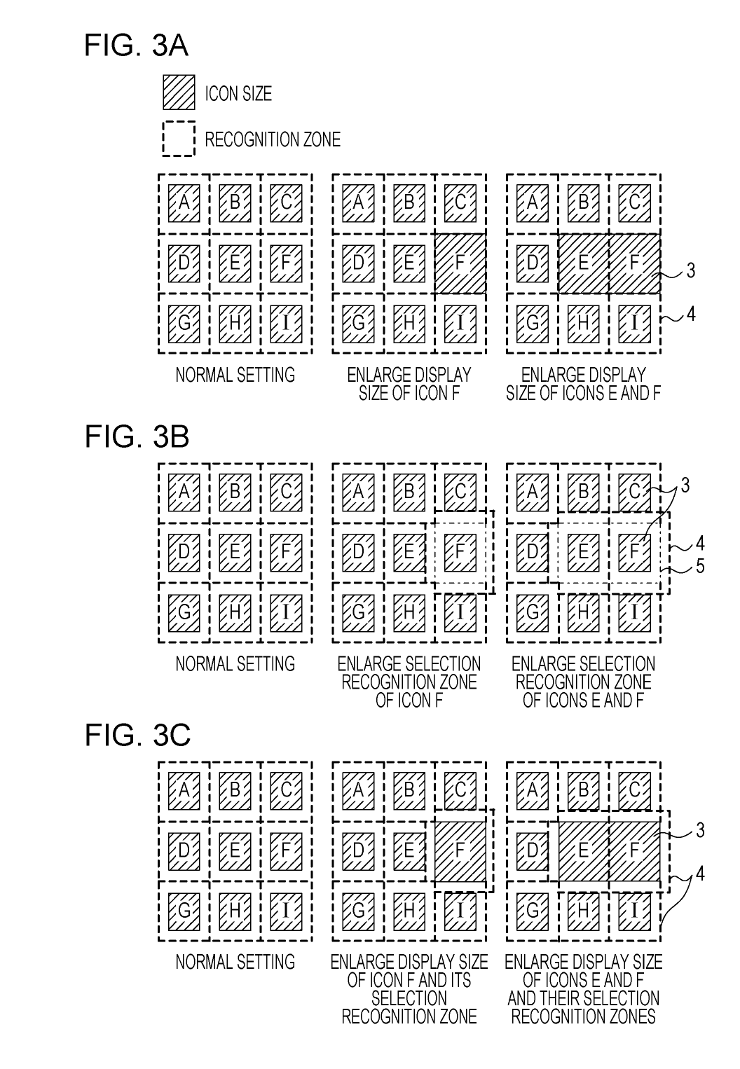

Turning to FIGS. 2A to 3C, icon display setting will be further described below. FIGS. 2A to 2D are diagrams illustrating display settings of icons 3. FIGS. 3A to 3C are diagrams illustrating exemplary display settings of icons 3 on the display screen of the touch panel 2.

FIG. 2A illustrates an exemplary icon 3 displayed on the display screen of the touch panel 2 with normal display setting. An icon 3 is a pictorial or symbol representation of the description or object of a function (processing), for example. The icon 3 is associated with a function, such as startup of an application or display of a particular website. When the icon 3 is selected via the touch panel, the function associated with the icon 3, such as startup of the application or display of the particular website, is executed. For the icon 3, a selection recognition zone 4 representing the range in which selection of the icon 3 is accepted is defined. For example, when the user touches inside a selection recognition zone 4 on the display screen of the touch panel with a finger or the like, the icon 3 associated with the selection recognition zone 4 is selected.

FIG. 2B illustrates an example of enlarging the display size of the icon 3. In FIG. 2B, the display size of the icon 3 is enlarged such that the display range of the icon 3 fills the entire selection recognition zone 4. FIG. 2C is an example of enlarging the selection recognition zone 4 of the icon 3. In FIG. 2C, the selection recognition zone 4 of the icon 3 is enlarged to a size larger than the normal setting (normal size 5 in FIG. 2C). FIG. 2D illustrates a case where both enlargement of the display size of icon 3 and enlargement of the selection recognition zone 4 of the icon 3, described above with reference to FIGS. 2B and 2C, are performed.

Next, referring to FIGS. 3A to 3C, display settings for icons 3 on the display screen of the touch panel 2 will be described. FIG. 3A is a diagram illustrating enlargement of the display size of icon 3 on the display screen of the touch panel 2. The left column of FIG. 3A illustrates an exemplary display screen of the touch panel 2 representing a case where normal display setting is configured for all icons 3. As depicted, all of icons 3, A through I, displayed on the display screen of the touch panel 2 are of the same normal display size, and their selection recognition zones 4 are also set to the same size.

The center column of FIG. 3A illustrates an exemplary display screen of the touch panel 2 representing a case where display setting for enlarging the display size of icon 3 F is made. As depicted, icons 3 A to E and G to I displayed on the display screen of the touch panel 2 are of the normal display size. In contrast, icon 3 F is displayed in an enlarged size because of the display setting for enlarging its display size. The right column illustrates the display screen of the touch panel 2 representing a case where display setting for enlarging the display size of icons 3 E and F is made. The icons 3 E and F are accordingly displayed in an enlarged size.

For example, by displaying frequently used icons 3 with emphasis, like icon 3 F in the center column and E and F in the right column in FIG. 3A, icons 3 frequently used by the user may be made easy to find. As a result, the icons 3 are easy to locate and thereby touching errors such as accidentally touching an icon 3 associated with an unintended application may be avoided.

FIG. 3B is a diagram illustrating enlargement of the selection recognition zones 4 of icons 3 on the display screen of the touch panel 2. Also in FIG. 3B, the left column illustrates an exemplary display screen with normal display setting.

The center column of FIG. 3B illustrates an exemplary display screen of the touch panel 2 with display setting for enlarging the selection recognition zone 4 of icon 3 F. As depicted, all of icons 3, A through I, displayed on the display screen of the touch panel 2 are of the normal display size. Thus, the appearance of the display screen as seen by the user remains unchanged. However, the display setting of icon 3 F is configured so as to enlarge its selection recognition zone 4, so the selection recognition zone 4 is enlarged. The icon 3 F may thus be selected in a larger area on the display screen of the touch panel 2, allowing the user to easily select the icon 3 F. Additionally, since the appearance of the display screen does not change with the change to the selection recognition zone 4, the user feels no sense of unfamiliarity in using the information processing apparatus 1.

The right column of FIG. 3B illustrates a case where display setting for enlarging the selection recognition zones 4 of icons 3 E and F is made and the selection recognition zones 4 of icons 3 E and F are accordingly enlarged. The icons 3 E and F may thus be selected in a larger area on the display screen of the touch panel 2, allowing the user to easily select the icons 3 E and F. With enlargement of the selection recognition zone 4 of a frequently used icon 3 in this manner, for example, selection of other icon 3 is avoided even if the user touches a position away from the intended icon 3, making the frequently used icon 3 easy to select. Thus, touching errors may be kept from occurring.

It is also possible to configure display settings in such a manner that the selection recognition zones 4 of neighboring icons 3 are both enlarged, like icons 3 E and F in the right column of FIG. 3B. When the selection recognition zones 4 of neighboring icons 3 are both enlarged, the selection recognition zones 4 may possibly overlap. In the example represented by the right column of FIG. 3B, in an area in which selection recognition zones 4 overlap as a result of their enlargement in such a case, the selection recognition zones 4 are demarcated exactly halfway between the neighboring two icons 3. In another embodiment, the frequencies of use of icons 3 whose selection recognition zones 4 overlap may be compared with each other, and higher priority may be given to enlargement of the selection recognition zone 4 of the icon 3 that has been selected more frequently so as to make its selection recognition zone 4 larger, for example.

FIG. 3C is a diagram illustrating enlargement of display size of icons 3 and enlargement of the selection recognition zone 4 on the display screen of the touch panel 2. Also in FIG. 3C, the left column illustrates an exemplary display screen with normal display setting.

The center column of FIG. 3C illustrates an exemplary display screen of the touch panel 2 with display setting for enlarging the display size of icon 3 F and its selection recognition zone 4. Accordingly, both the display size of icon 3 F and its selection recognition zone 4 are enlarged, as depicted. This setting provides both the effects described above with reference to FIGS. 3A and 3B; icon F is easy to find and select on the display screen of the touch panel 2.

The right column of FIG. 3C illustrates a case where display setting is configured so as to enlarge the display size of icons 3 E and F and their selection recognition zones 4 and accordingly the display size of icons 3 E and F and their selection recognition zones 4 are enlarged. The icons 3 E and F are thus easy to find and select on the display screen of the touch panel 2. When display setting is configured to enlarge the selection recognition zones 4 of neighboring icons 3 and the selection recognition zones 4 of the two icons 3 overlap as a result of enlargement, the selection recognition zones 4 may be defined as described above in relation to the right column of FIG. 3B, for example.

As described above with reference to FIGS. 3A to 3C, emphasized display of icons 3 on the display screen of the touch panel 2 with display settings of the icons 3 makes the icons 3 easy to find. In addition, enlargement of the selection recognition zone 4 of an icon 3 on the touch panel 2 with display setting of the icon 3 makes the icon 3 easy to select.

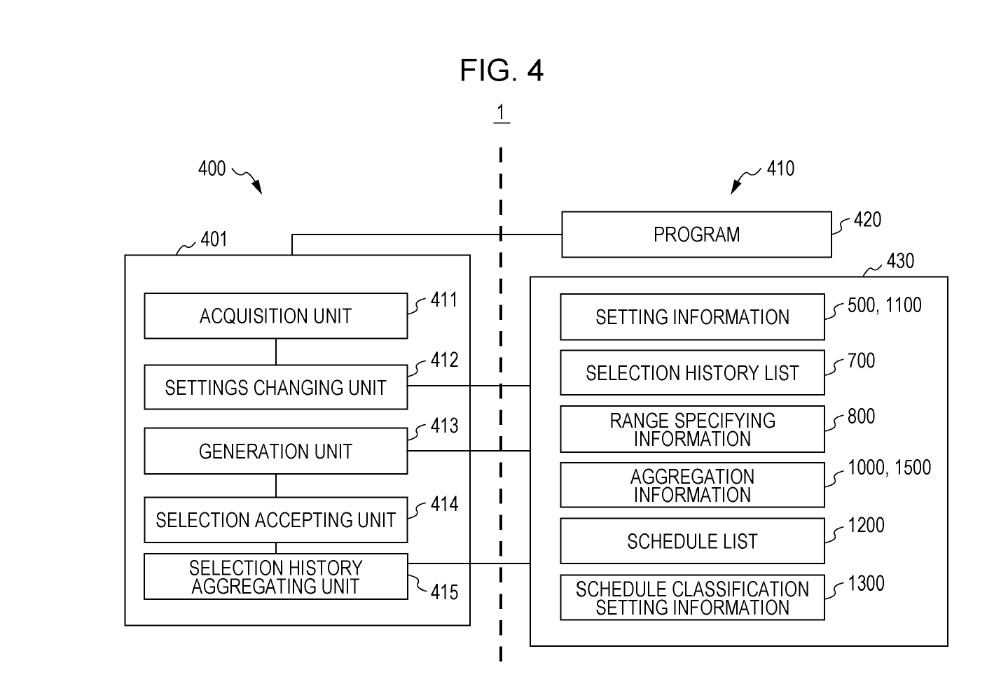

FIG. 4 is a diagram illustrating an example of a functional configuration of an information processing apparatus, according to an embodiment. FIG. 4 illustrates an exemplary functional block configuration of the information processing apparatus 1. A control unit 400 of the information processing apparatus 1 includes a functional unit 401, which includes an acquisition unit 411, a settings changing unit 412, a generation unit 413, a selection accepting unit 414, and a selection history aggregating unit 415. A storage unit 410 of the information processing apparatus 1 contains a program 420. The control unit 400 reads and executes the program 420 to function as the functional unit 401, such as the acquisition unit 411, settings changing unit 412, generation unit 413, selection accepting unit 414, and selection history aggregating unit 415. The storage unit 410 contains information 430, such as setting information 500, 1100, selection history list 700, range specifying information 800, aggregation information 1000, 1500, schedule list 1200, and schedule classification setting information 1300. Details of the individual units included in the functional unit 401 and information stored in the storage unit 410 will be described later.

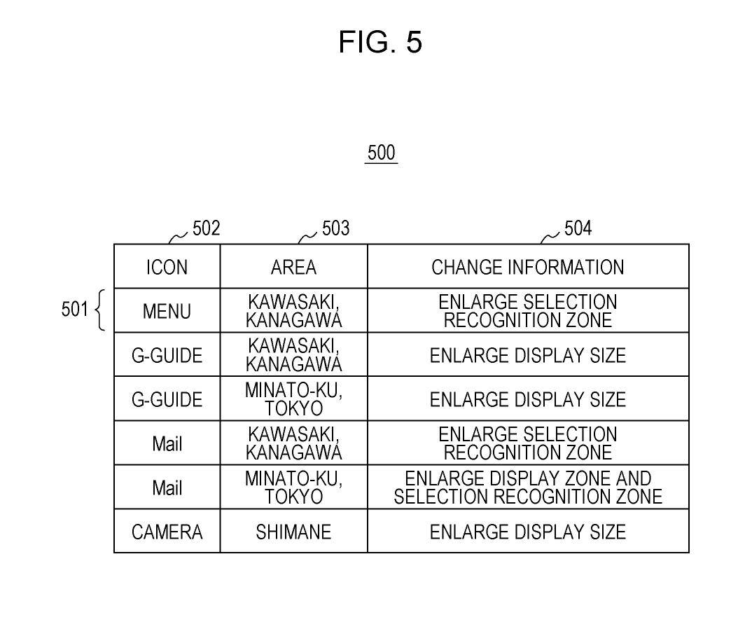

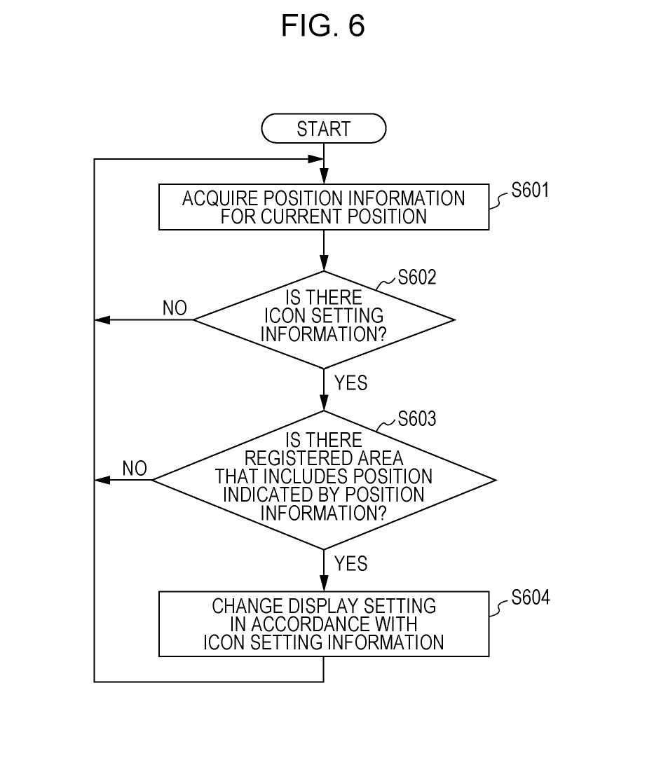

Referring to FIGS. 5 and 6, changing of icon display settings based on position information according to a first embodiment will be described.

FIG. 5 is a diagram illustrating an example of setting information, according to a first embodiment. In an embodiment, the setting information 500 is information used for changing display settings of icons 3 displayed on the display screen of the touch panel 2 of the information processing apparatus 1 on the basis of position information. In an embodiment, the setting information 500 is stored in the storage unit 410 of the information processing apparatus 1. The setting information 500 stores pieces of icon setting information 501 (entries) for changing display settings of an icon. In the icon setting information 501, icon 502, area 503, and change information 504 are stored in association with each other. The icon 502 is information for identifying the icon 3 for which display settings are to be changed using the icon setting information 501. The area 503 is information about a geographical area in relation to which display settings are to be applied in accordance with the icon setting information 501. The change information 504 is information used for changing the display settings for displaying the icon 3 identified by the icon 502 on the display screen. The change information 504 includes changes of display settings, such as enlargement of display size of the icon 3 and its selection recognition zone 4 described above.

In the setting information 500 of FIG. 5, settings for the icon 3 identified by “mail” are configured so as to enlarge its selection recognition zone 4 in “Kawasaki, Kanagawa”, for example. Likewise, settings for the icon 3 identified by “mail” are also configured so as to enlarge the display size of the icon 3 and its selection recognition zone 4 in “Minato-ku, Tokyo”. As another example, settings of the icon 3 identified by “camera” are configured so as to enlarge its display in “Shimane”. The “mail” icon 502 may be an icon associated with a function for starting an application such as mailing software. When the user selects a position within the selection recognition zone 4 of the “mail” icon 3 on the display screen via the touch panel 2, for example, activation of the mailing software is executed. The setting information 500 may be generated by causing the user to register icon setting information 501, by the generation process for setting information 500 described later, or by combination thereof, for example.

FIG. 6 is a diagram illustrating an example of an operational flowchart for changing icon display settings, according to a first embodiment. FIG. 6 illustrates the process of changing icon display settings based on the setting information 500 executed by the control unit 400 of the information processing apparatus 1 according to the first embodiment. The operational flowchart of FIG. 6 is carried out by causing the control unit 400 of the information processing apparatus 1 to read and execute the program 420 stored in the storage unit 410, for example. In an embodiment, the process of changing icon display settings starts when the information processing apparatus 1 is started up. At step S601, the control unit 400 acquires position information, which is information about the current position of the information processing apparatus 1, using a GPS receiver or a wireless LAN receiver included in the information processing apparatus 1, for example. The position information acquired by the information processing apparatus 1 may be latitude and longitude information, or information on the address of the current position, for example. Latitude/longitude information and address information may be translated to each other by use of various techniques (for example, by prestoring information that maps latitude/longitude to addresses in the information processing apparatus 1, or via a website on a network that distributes map information).

At step S602, the control unit 400 determines whether or not any icon setting information 501 is registered in the setting information 500 by referencing the setting information 500 stored in the storage unit 410. When no icon setting information 501 is registered (No at step S602), the flow returns to step S601. When icon setting information 501 is registered (Yes at step S602), the flow proceeds to step S603. At step S603, the control unit 400 determines whether or not an area containing the position indicated by the position information acquired at step S601 is registered in the area 503 of the icon setting information 501.

When no area containing the position indicated by the position information acquired at step S601 is registered in the area 503 of the icon setting information 501 (No at step S603), the flow returns to step S601. When an area containing the position indicated by the position information acquired at step S601 is registered in the area 503 of the icon setting information 501 (Yes at step S603), the flow proceeds to step S604. At step S604, the control unit 400 acquires icon 502 and change information 504 from the icon setting information 501 (entry) that has the position indicated by the position information acquired at step S601 in area 503. The control unit 400 then changes the icon 3 identified by the icon 502 acquired in accordance with the change information 504 acquired.

The operation flow of FIG. 6 will be further described below with specific examples. By way of example, suppose that the current position information acquired at step S601 is “X-X, YYY X-chome, XXX-ku, Yokohama, Kanagawa”. In this case, since there is icon setting information 501 registered in the setting information 500 of FIG. 5, determination at step S602 results in Yes and the flow proceeds to step S603. At step S603, reference is made to the setting information 500. Since the setting information 500 of FIG. 5 includes no icon setting information 501 (entry) in which area 503 contains “X-X, YYY X-chome, XXX-ku, Yokohama, Kanagawa”, determination at step S603 results in No and the flow returns to step S601.

Suppose now that the current position information acquired at step S601 is “X-X, YYY X-chome, Minato-ku, Tokyo”. In this case, since there is icon setting information 501 registered in the setting information 500 of FIG. 5, determination at step S602 results in Yes and the flow proceeds to step S603. At step S603, reference is made to the setting information 500. In the setting information 500 of FIG. 5, two pieces of icon setting information 501 (two entries) with area 503 containing “X-X, YYY X-chome, Minato-ku, Tokyo” are registered. Determination at step S603 accordingly results in Yes and the flow proceeds to step S604. At step S604, icon 502 and change information 504 are acquired from the two pieces of icon setting information 501 that have “Minato-ku, Tokyo” in area 503 of setting information 500. Specifically, the icon “G-guide” and the corresponding change information 504 (enlarge display size), and the icon “mail” and the corresponding change information 504 (enlarge display size and selection recognition zone) are acquired. In accordance with the change information 504 acquired, icon display settings are changed. Specifically, the display size of the G-guide icon 3 is enlarged, and the display size of the mail icon 3 and its selection recognition zone 4 are enlarged on the display screen.

As described above, in the first embodiment, display setting of icons 3 is changed in accordance with position information for the current position of the information processing apparatus 1. For example, by registering in the setting information 500 icon setting information 501 defined so as to facilitate selection of icons 3 that are frequently used in a certain area in association with that area, the frequently used icons 3 are made easy to select in accordance with position information for the current position. Thus, the chance of touching errors, such as inadvertently touching a different icon 3 than the intended one, may be reduced.

It is also conceivable to change the display setting of frequently used icons 3 so as to facilitate their selection in accordance with time period. However, frequency of use of icons 3 may be affected more by area than time period.

For example, consider changing of display settings of frequently used icons 3 so as to facilitate their selection in accordance with time period. Then, suppose, for example, that the user is usually at the office from 9 a.m. to 5 p.m. on weekdays and accordingly makes settings for changing the display setting of icons 3 that the user frequently use at the office so as to facilitate their selection during this time period and makes settings for changing the display setting of icons 3 that user often uses privately so as to facilitate their selection in other time periods. In this case, when the user goes to work on a holiday or works overtime, display settings of icons 3 which the user frequently uses privately are changed so as to facilitate selection of those icons 3 even though the user is at the office. Furthermore, when the user takes a paid leave, display settings for icons 3 that the user frequently uses at the office are changed so as to facilitate selection of those icons 3 even though the user is having private time.

Such situations do not occur with area-based control of display setting for icons 3 as described in the first embodiment. That is, even when the user follows a different schedule than usual, display settings for icons 3 may be changed on the basis of area, so icons 3 that are frequently used at the office become easy to select when the user is at the office and icons 3 that are frequently used at home become easy to select when the user is at home. Therefore, the operability of the information processing apparatus 1 is improved.

Furthermore, area-based change of display setting of icons 3 enables display settings of icons 3 to be configured appropriately or more specifically for occasional events. For example, suppose that the user travels to Nagoya on business several times a month but dates of trip are not fixed and may be set up suddenly. When in Nagoya, the user frequently uses an icon 3 for a presentation application, for example, which the user does not use very often at the office or personally. As another example, the user likes traveling to Okinawa once or twice a year and while staying in Okinawa frequently uses icons 3 for map and positioning applications which the user does not use very often usually.

If display settings for icons responsive to such irregular events are configured based on time period, the user has to make settings each time a schedule is fixed, which is difficult or burdensome to the user. In the first embodiment, since icon display setting is changed per area, display setting of icons 3 that are frequently used in a certain area may be changed so that those icons 3 become easy to select in accordance with the user's current position whenever the user goes to the area, even if on an irregular schedule. Thus, the operability of the information processing apparatus 1 may be improved.

In the processing performed at step S601 of FIG. 6, the control unit 400 of the information processing apparatus 1 functions as the acquisition unit 411, for example. In the processing performed at steps S602 through S604, the control unit 400 of the information processing apparatus 1 functions as the settings changing unit 412, for example.

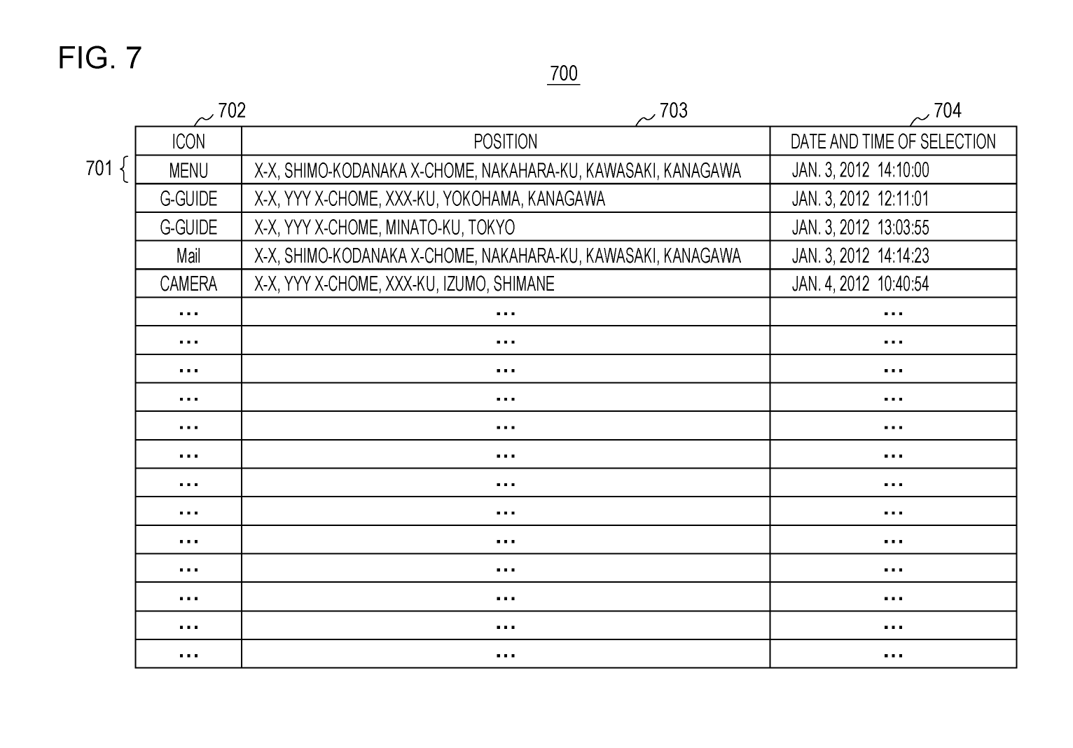

Turning to FIGS. 7 to 9, the process of generating setting information 500 according to embodiments will be described. The process of generating setting information 500 is not limited to the one described below; setting information 500 may be generated by causing the user to register pieces of icon setting information 501 individually, for example.

FIG. 7 is a diagram illustrating an example of a selection history list for icons, according to an embodiment. FIG. 7 illustrates an example of selection history list 700 for icons 3. The selection history list 700 includes selection history information 701 (entry). The selection history information 701 includes information on icon 702, position 703, and date and time of selection 704, and these pieces of information are associated by selection history information 701. Icon 702 is information for identifying a selected icon. Position 703 is information indicating the position of the information processing apparatus 1 when the icon was selected. Date and time of selection 704 is information indicating the date and time at which the icon was selected. For example, the uppermost selection history information 701 (entry) in the selection history list 700 indicates that the “menu” icon was selected at 14:10:00 on Jan. 3, 2012. It also indicates that the selection took place when the information processing apparatus 1 was at “X-X, Shimo-kodanaka X-chome, Nakahara-ku, Kawasaki, Kanagawa”. As described, the selection history list 700 is information which stores history of selections of icons 3 on the touch panel 2 of the information processing apparatus 1.

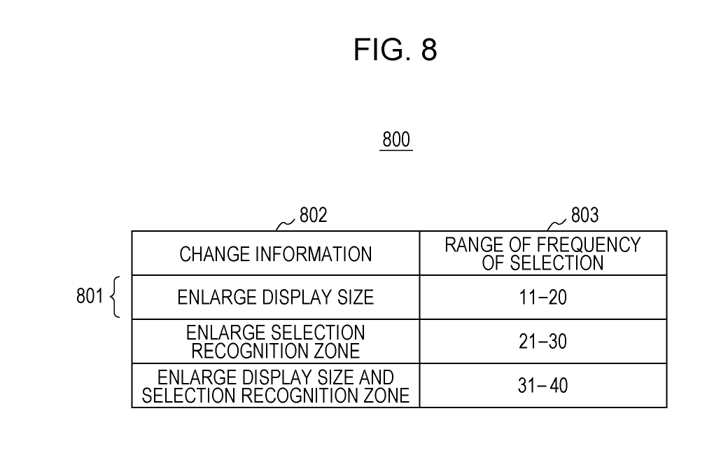

FIG. 8 is a diagram illustrating an example of range specifying information, according to an embodiment. The range specifying information 800 includes display-setting specifying information 801 (entry), which includes icon change information 802 and range of frequency of selection 803. The display-setting specifying information 801 indicates that display settings of an icon are to be changed in accordance with change information 802 when the number of times the icon has been selected falls within the range of frequency of selection 803. For example, when a certain icon 3 has been selected 22 times within a predetermined period, the number of its selections falls within the range of frequency of selection 803 of 21 to 30. Thus, for this icon 3, settings are configured in accordance with icon change information 802 that corresponds to the range of frequency of selection 803 of 21 to 30, that is, enlarging of selection recognition zone.

In FIG. 8, the range specifying information 800 includes three pieces of display-setting specifying information 801 (three entries) that have as change information 802: enlarge display size, enlarge selection recognition zone, and enlarge display size and selection recognition zone. The change information 802 is not limited to them, however. For example, the range specifying information 800 may not include one or more of “enlarge display size”, “enlarge selection recognition zone”, and “enlarge display size and selection recognition zone”, as change information 802. Alternatively, other kinds of change information 802 may be additionally defined in the display-setting specifying information 801. Also, in the display-setting specifying information 801, “enlarge display size”, “enlarge selection recognition zone”, and “enlarge display size and selection recognition zone” are assigned in ascending order of range of frequency of selection 803. However, the order of range assignment of display-setting specifying information 801 is not limited to the illustrated one; change information 802 may be defined in a different order. In addition, the range of frequency of selection 803 associated with change information 802 for an icon may be set to certain values within a range that is defined so as not to overlap the range of frequency of selection 803 of change information 802 for other icons. The range specifying information 800 may be created separately for each icon 3, for example.

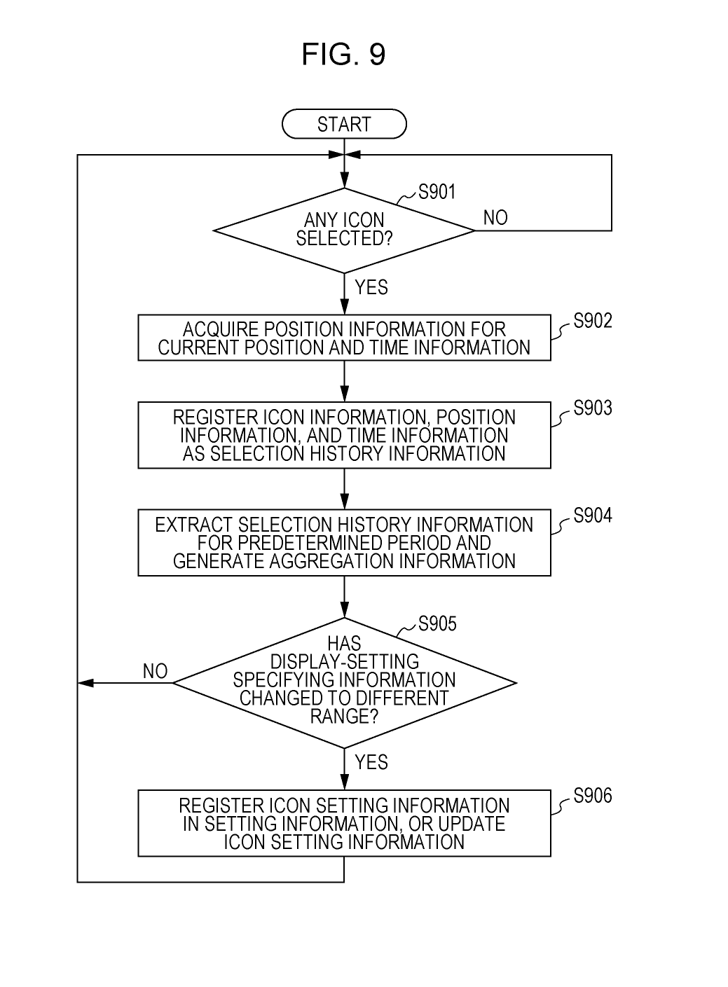

FIG. 9 is a diagram illustrating an example of an operational flowchart for generating setting information, according to an embodiment. FIG. 9 is an exemplary operation flowchart illustrating the process of generating the setting information 500 executed by the control unit 400 of the information processing apparatus 1 according to the first embodiment. The operation flow of FIG. 9 is carried out by the control unit 400 of the information processing apparatus 1 reading and executing the program 420 stored in the storage unit 410, for example. In an embodiment, the process of generating the setting information 500 starts when the information processing apparatus 1 is started up. At step S901, the control unit 400 of the information processing apparatus 1 determines whether or not any icon 3 has been selected on the display screen of the information processing apparatus 1. When no icon 3 has been selected (No at step S901), the flow returns to step S901 where the process is repeated. When an icon 3 has been selected (Yes at step S901), the flow proceeds to step S902. At step S902, the control unit 400 of the information processing apparatus 1 acquires position information indicating the current position and time information (date and time of selection) which indicates the present time. The control unit 400 may acquire position information for the current position using a GPS or wireless-LAN receiver contained in the information processing apparatus 1, for example. The control unit 400 may also acquire present time information as the date and time of icon selection via a clock included in the information processing apparatus 1 or a website that provides present time information. While the present embodiment is described by taking a case where address is used as position information for the current position as an example, the embodiment is not limited thereto. For example, latitude and longitude information may be used as position information. As mentioned above, an address and latitude/longitude are pieces of information that may be translated to each other.

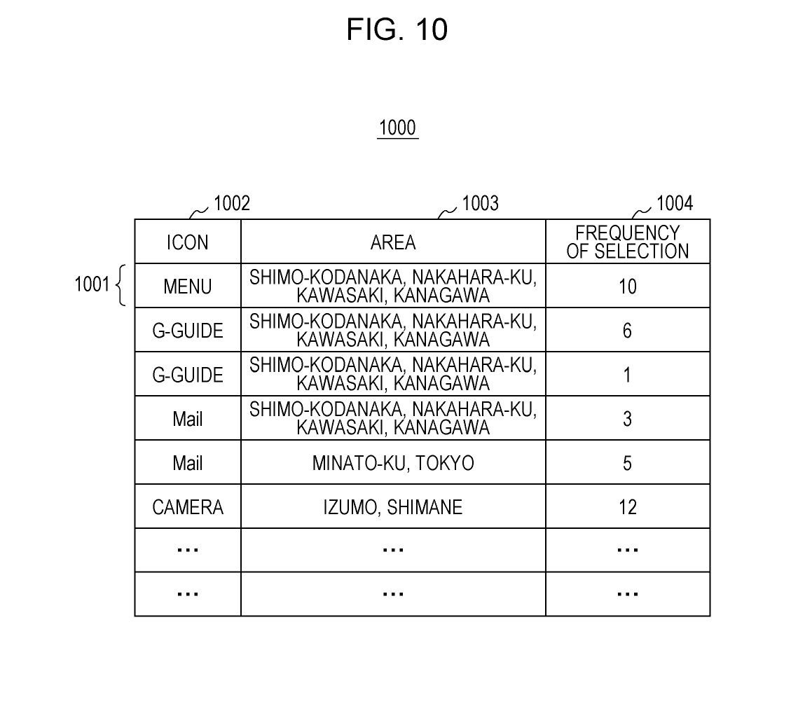

Then, at step S903, the control unit 400 of the information processing apparatus 1 registers the icon information for the icon 3 selected at step S901 in the selection history list 700 as selection history information 701, in association with the position information and time information acquired at step S902. Next, at step S904, reference is made to selection history list 700, and selection history information 701 having date and time of selection 704 that falls within a predetermined period is extracted. The predetermined period may be an arbitrary period. For example, it is set to a period of time over which usage of icons 3 by the user may be ascertained, such as 30 days. Then, based on the selection history information 701 extracted, information on how many times each icon 3 has been selected in which area within the predetermined period is aggregated, thereby generating aggregation information 1000. FIG. 10 is a diagram illustrating an example of aggregation information, according to an embodiment. The aggregation information 1000 includes icon selection aggregation information 1001 (entry), which includes icon 1002, area 1003, and frequency of selection 1004. The icon selection aggregation information 1001 indicates that the icon identified by icon 1002 was selected the number of times indicated by the frequency of selection 1004 while the information processing apparatus 1 was located in the area 1003 within the predetermined period that is used at step S904 for extraction of selection history information 701.

Next, at step S905, reference is made to pieces of icon selection aggregation information 1001 (entries) registered in aggregation information 1000. It is then determined whether or not there is any icon selection aggregation information 1001 whose frequency of selection 1004 has changed to display-setting specifying information 801 corresponding to a different range of frequency of selection 803 as a result of the icon 3 being selected at step S901. When there is no icon selection aggregation information 1001 (entry) whose display-setting specifying information 801 has changed to a different range (No at step S905), the flow returns to step S901. When there is icon selection aggregation information 1001 whose display-setting specifying information 801 has changed to a different range (Yes at step S905), the flow proceeds to step S906. At step S906, the control unit 400 of the information processing apparatus 1 acquires icon 1002 and area 1003 from the icon selection aggregation information 1001 whose display-setting specifying information 801 has changed to a different range. The acquired icon 1002 and area 1003 are associated with change information 802 included in the currently corresponding display-setting specifying information 801 and registered in setting information 500 as icon setting information 501. It is possible that icon setting information 501 including the acquired icon 1002 and area 1003 is already registered in setting information 500. In that case, the value of change information 504 for the icon corresponding to the already registered icon setting information 501 is updated to change information 802 of the currently corresponding display-setting specifying information 801. After registration of icon setting information 501 in setting information 500 or update of icon setting information 501 at step S906, the flow returns to step S901.

Through the operation flow of FIG. 9 described above, the setting information 500 illustrated in FIG. 5 is generated. The operation flow of FIG. 9 aggregates the number of times icons 3 have been selected based on the area in which the information processing apparatus 1 is located. For an icon 3 which is frequently used in the current area in which the information processing apparatus 1 is located, icon setting information 501 having change information 504 that makes the icon 3 easy to select when the information processing apparatus 1 is in that area 503 is registered in setting information 500. This may generate the setting information 500 without any option for the user to decide which icons 3 he/she often uses in which area on his/her own and manually create the setting information 500.

In the processing performed at step S901 in FIG. 9, the control unit 400 of the information processing apparatus 1 functions as the selection accepting unit 414, for example. In the processing performed at step S902 through S904, the control unit 400 of the information processing apparatus 1 functions as the selection history aggregating unit 415, for example. In the processing performed at steps S905 and S906, the control unit 400 of the information processing apparatus 1 functions as the generation unit 413, for example.

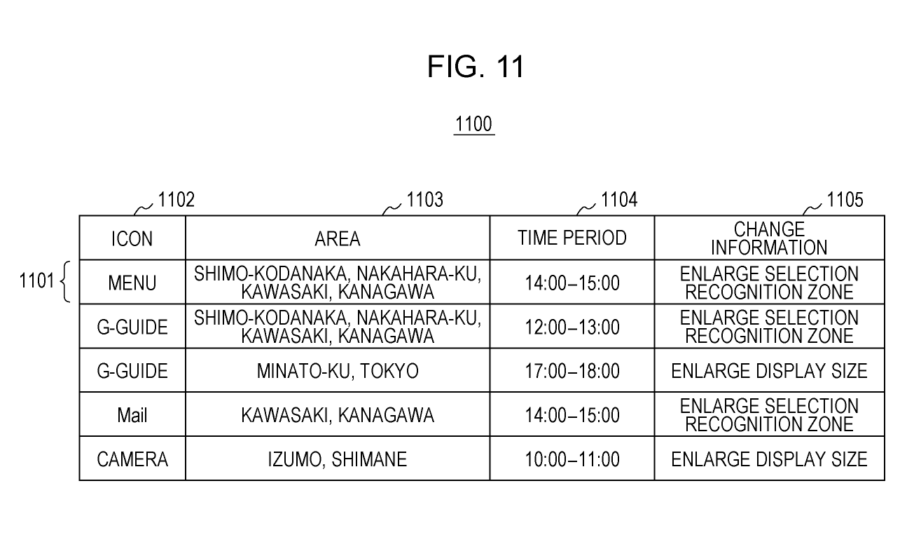

Next, referring to FIGS. 11 to 14, the process of changing icon display settings according to a second embodiment will be described. In the example described in the first embodiment, display settings for icons 3 displayed on the display screen of the touch panel 2 of the information processing apparatus 1 are changed on the basis of position information. The second embodiment illustrates a case where display settings for icons 3 displayed on the display screen of the information processing apparatus 1 are changed also on the basis of time period and schedule in addition to position information.

FIG. 11 is a diagram illustrating an example of setting information, according to a second embodiment. FIG. 11 illustrates an example of setting information 1100 according to the second embodiment. In an embodiment, the setting information 1100 is information used for changing the display setting of icons 3 displayed on the display screen of the touch panel 2 of the information processing apparatus 1 based on position information and time period. In an embodiment, the setting information 1100 is stored in the storage unit 410 of the information processing apparatus 1. In the setting information 1100, icon setting information 1101 is registered. The icon setting information 1101 includes information on icon 1102, area 1103, time period 1104, and change information 1105. The setting information 1100 is information corresponding to the setting information 500 in the first embodiment. For instance, icon 1102, area 1103, and change information 1105 correspond to icon 502, area 503, and change information 504, respectively, and they may be similar information. The setting information 1100 further includes time period 1104 indicating time periods in which icon display settings are to be changed in accordance with change information 1105.

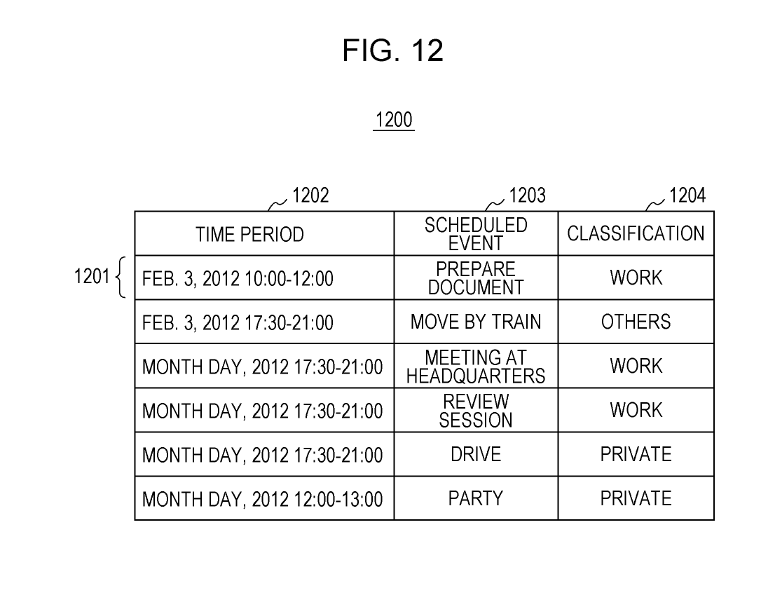

FIG. 12 is a diagram illustrating an example of a schedule list, according to a second embodiment. FIG. 12 illustrates an example of schedule list 1200 according to the second embodiment. In an embodiment, the schedule list 1200 is stored in the storage unit 410 of the information processing apparatus 1. The schedule list 1200 is information indicating the schedule of the user of the information processing apparatus 1. The schedule list 1200 includes schedule 1201 (as each entry). The schedule 1201 includes time period 1202, scheduled event 1203, and classification 1204. The time period 1202 is information indicating the time period of the scheduled event indicated in the schedule 1201. The scheduled event 1203 is information indicating the details of the plan indicated in the schedule 1201. The classification 1204 is information indicating the category of the event indicated in the schedule 1201, including “work”, “private”, and “others” in FIG. 12, for example.

For example, the schedule 1201 represented in the topmost row (entry) of the schedule list 1200 indicates that the user is scheduled to prepare documents from 10:00 to 12:00 on Feb. 3, 2012 and that the activity is classified as “work”. The following row (entry) indicates that the user is scheduled to move by train from 17:30 to 21:00 on the same day and the activity is classified as “others”. Such schedule list 1200 is stored in the storage unit 410 of the information processing apparatus 1. The schedule list 1200 may be configured by the user in order to practice the second embodiment, for example. It has recently become common for users to manage their schedule using schedule management software incorporated in the information processing apparatus 1, such as a smartphone. Information generated by such schedule management software may be utilized as schedule list 1200, for example. Alternatively, the schedule list 1200 may be information generated from schedule stored in schedule management software.

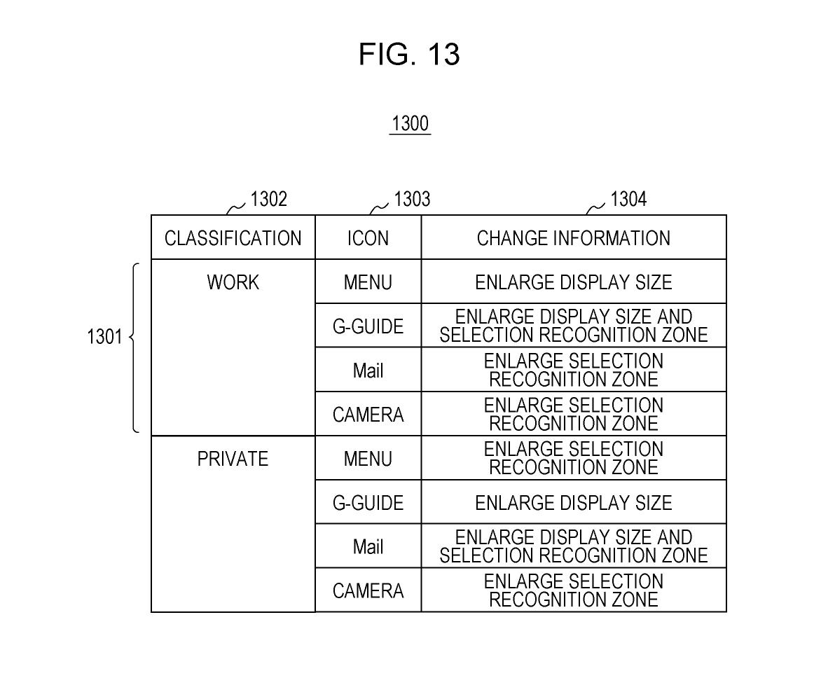

FIG. 13 is a diagram illustrating an example of schedule classification setting information, according to a second embodiment. FIG. 13 illustrates an example of schedule classification setting information 1300 according to the second embodiment. In an embodiment, the schedule classification setting information 1300 is stored in the storage unit 410 of the information processing apparatus 1. The schedule classification setting information 1300 includes display-setting specifying information 1301 (as each entry). The display-setting specifying information 1301 is information that specifies icon display settings in accordance with schedule classification. The display-setting specifying information 1301 includes classification 1302, icon 1303, and change information 1304. The classification 1302, which corresponds to classification 1204 of schedule 1201, is information indicating the category of a scheduled event. The icon 1303 is information identifying the icon for which display settings are specified by display-setting specifying information 1301. The change information 1304 is information used for changing the display settings of the icon identified by the icon 1303. Since the classification 1302 corresponds to classification 1204 of schedule 1201 as mentioned above, change information 1304 for an icon appropriate for the classification 1204 of schedule 1201 may be taken from the schedule classification setting information 1300. The schedule classification setting information 1300 may be information generated by the user of the information processing apparatus 1, for example.

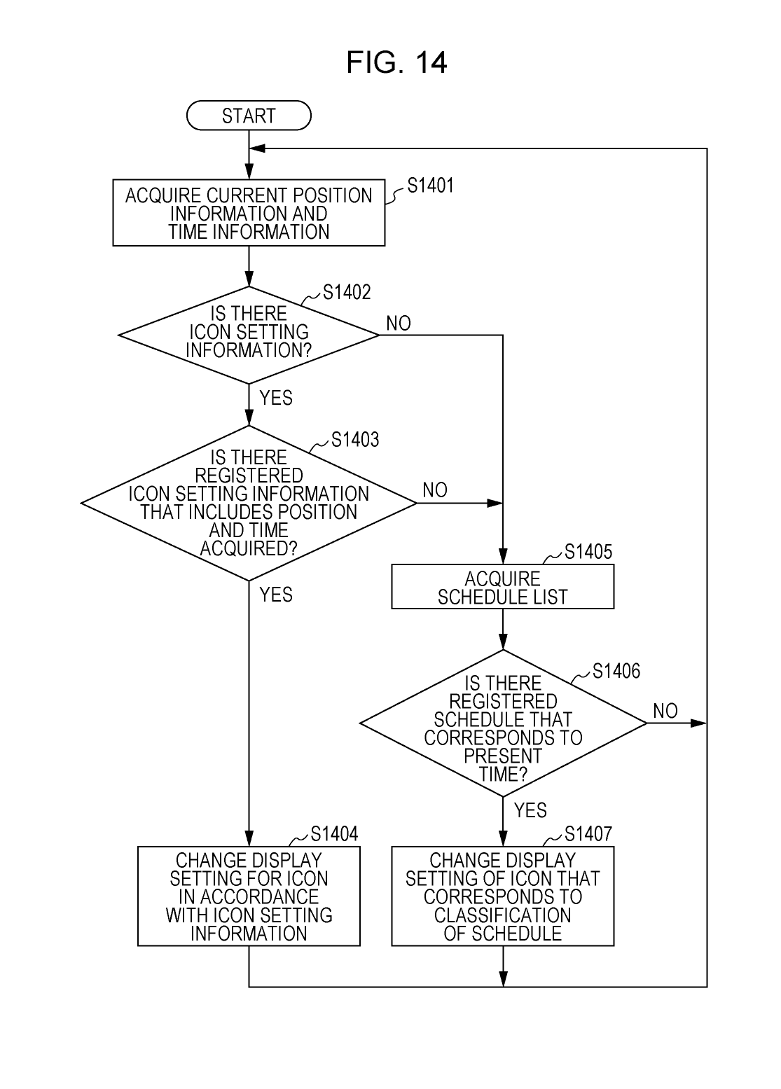

FIG. 14 is a diagram illustrating an example of en operational flowchart for changing icon display settings, according to a second embodiment. FIG. 14 is an exemplary operational flowchart illustrating the process of changing icon display settings executed by the control unit 400 of the information processing apparatus 1 according to the second embodiment. The operation flow of FIG. 14 corresponds to the operation flow of FIG. 6 according to the first embodiment. In an embodiment, the operation flow of FIG. 14 starts when the information processing apparatus 1 is started up. At step S1401, the control unit 400 acquires position information, which is information about the current position of the information processing apparatus 1, using a GPS receiver or a wireless LAN receiver contained in the information processing apparatus 1, for example. The control unit 400 also acquires time information representing the present time via a clock included in the information processing apparatus 1 or a website that provides present time information.

As in the first embodiment, position information acquired by the information processing apparatus 1 may be information on the latitude and longitude of the current position, or information on the address of the current position, for example. Latitude/longitude information and an address may be translated to each other by use of various techniques, such as by prestoring a table that maps latitude/longitude to addresses in the information processing apparatus 1 or via a website on a network that distributes map information.

Next, at step S1402, the control unit 400 determines whether or not any icon setting information 1101 (entry) is registered in setting information 1100 by referencing the setting information 1100 stored in the storage unit 410. When no icon setting information 1101 is registered (No at step S1402), the flow proceeds to step S1405. When icon setting information 1101 is registered (Yes at step S1402), the flow proceeds to step S1403.

At step S1403, the control unit 400 determines whether or not any icon setting information 1101 (entry) that has area 1103 containing the current position acquired at step S1401 and time period 1104 containing the time acquired at step S1401 is registered in setting information 1100. When no such icon setting information 1101 is registered (No at step S1403), the flow proceeds to step S1405. When such icon setting information 1101 is registered (Yes at step S1403), the flow proceeds to step S1404. At step S1404, the control unit 400 acquires icon 1102 and change information 1105 from the icon setting information 1101 that has area 1103 containing the position information acquired at step S1401 and time period 1104 containing the time information. The control unit 400 then changes the display settings of the icon 3 identified by the acquired icon 1102 in accordance with the acquired change information 1105, after which the operation flow returns to step S1401.

When determination at step S1402 or S1403 results in No, the flow proceeds to step S1405 as mentioned above. At step S1405, the control unit 400 acquires schedule list 1200, and the flow proceeds to step S1406. At step S1406, it is determined whether or not any schedule 1201 (entry) corresponding to the present time acquired at step S1401 is registered in the schedule list 1200. When no schedule 1201 (entry) corresponding to the present time is registered at step S1406 (No at step S1406), the flow returns to step S1401. When there is registered schedule 1201 corresponding to the present time at step S1406 (Yes at step S1406), the flow proceeds to step S1407.

At step S1407, the control unit 400 of the information processing apparatus 1 identifies display-setting specifying information 1301 (entry) having classification 1302 that matches the classification 1204 of the schedule 1201 whose time period 1202 contains the present time. The control unit 400 then changes the display setting of the icon 3 identified by the icon 1303 of the display-setting specifying information 1301 identified to the display setting indicated in the change information 1304. As represented in FIG. 13, when display-setting specifying information 1301 includes multiple icons 1303 and multiple pieces of change information 1304, display setting of the icon 3 identified by each of the icons 1303 is changed to the display setting indicated in the corresponding change information 1304. After changing of icon display setting at step S1407, the flow returns to step S1401.

As described above, the operation flow of FIG. 14 determines whether or not icon setting information 1101 (entry) that corresponds to the current position and present time is registered in setting information 1100 (steps S1401 to S1403 in FIG. 14). When there is registered icon setting information 1101 that corresponds to the current position and present time, display setting of the icon 3 is changed in accordance with the display setting indicated in the icon setting information 1101 (step S1404 in FIG. 14). When no icon setting information 1101 corresponding to the current position and present time is registered, it is then determined whether or not there is any registered schedule corresponding to the present time with reference to schedule (steps S1405 to S1406 in FIG. 14). When there is a registered schedule that corresponds to the present time, display settings of icons 3 are changed in accordance with the classification of the schedule (step S1407 in FIG. 14).

As described above, in the second embodiment, display settings of icons 3 are changed in accordance with time period even when the user stays in one area. This enables changing of display settings of frequently used icons in accordance with time period so as to facilitate their selection even when the user stays in one area, in addition to providing the ability to change display settings of frequently used icons so as to facilitate their selection in accordance with the user's position.

Additionally, in the second embodiment, when a schedule corresponding to the present time is found by referencing the user's schedule, display settings for icons 3 are changed in accordance with the classification of the schedule. Thus, when there is an event registered in the user's schedule, display setting for frequently used icons may be changed in accordance with the classification of the event regardless of area. In the operation flow of FIG. 14, change of display settings of icons 3 in accordance with current position and present time is given higher priority by being positioned upstream of change of display settings of icons 3 in accordance with schedule. However, the flow to change display settings of icons 3 in accordance with schedule may be positioned upstream the flow to change display settings of icons 3 in accordance with current position and present time so that priority is given to schedule-based change of display settings of icons 3, for example. Alternatively, change of display settings of icons 3 in accordance with schedule may be combined with the change of display settings based on position information according to the first embodiment, or implemented singly. By changing icon display settings using schedule information, display settings may be configured in accordance with schedule classification so that appropriate (for example, frequently used) icons become easy to select. Thus, the operability of the information processing apparatus 1 may be improved.

In the processing performed at step S1401 of FIG. 6, the control unit 400 of the information processing apparatus 1 functions as the acquisition unit 411, for example. In the processing performed at step S1402 through S1407, the control unit 400 of the information processing apparatus 1 functions as the settings changing unit 412, for example.

Now, referring to FIGS. 7, 15, and 16, the process of generating setting information 1100 according to the second embodiment will be described. The process of generating setting information 1100 is not limited to the one described below; the setting information 1100 may be generated by causing the user to register pieces of icon setting information 1101 (entry) individually, for example.

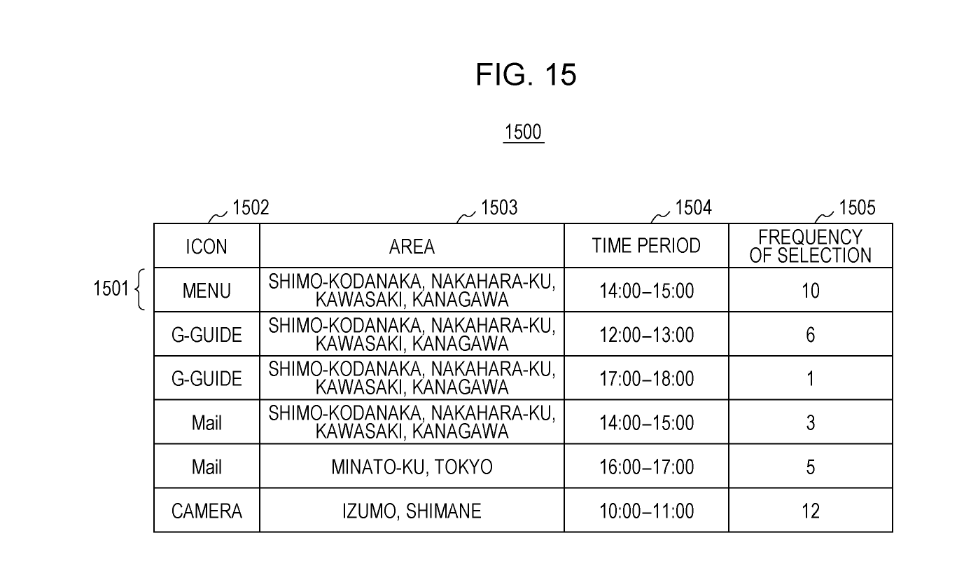

FIG. 15 is a diagram illustrating an example of aggregation information, according to a second embodiment. FIG. 15 illustrates an example of aggregation information 1500 according to the second embodiment. In an embodiment, the aggregation information 1500 is stored in the storage unit 410 of the information processing apparatus 1. The aggregation information 1500 is information generated based on selection history list 700, for example. The aggregation information 1500 includes icon selection aggregation information 1501 (as each entry), which includes icon 1502, area 1503, time period 1504, and frequency of selection 1505. The icon selection aggregation information 1501 is information that indicates the icon 3 identified by icon 1502 was selected the number of times indicated by frequency of selection 1505 while the information processing apparatus 1 was located in the area indicated by area 1503 during the time period indicated by time period 1504 within a predetermined period.

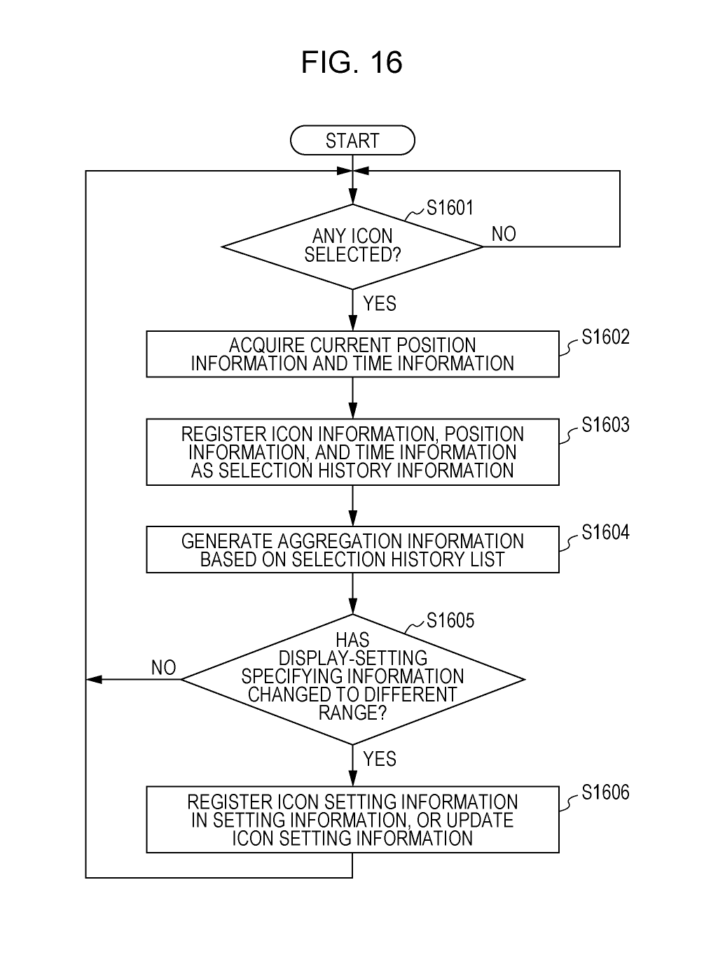

FIG. 16 is a diagram illustrating an example of an operational flowchart for generating setting information, according to a second embodiment. FIG. 16 is an exemplary operational flowchart illustrating the process of generating setting information 1100 executed by the control unit 400 of the information processing apparatus 1. The operation flow of the process of generating setting information 1100 illustrated in FIG. 16 is carried out by the control unit 400 of the information processing apparatus 1 reading and executing the program 420 stored in the storage unit 410, for example. In an embodiment, the process of generating setting information 1100 starts when the information processing apparatus 1 is started up. At step S1601, the control unit 400 of the information processing apparatus 1 determines whether or not any icon 3 has been selected. When no icon 3 has been selected (No in step S1601), the flow returns to step S1601, where the process is repeated. When an icon 3 has been selected (Yes in step S1601), the flow proceeds to step S1602. At step S1602, the control unit 400 of the information processing apparatus 1 acquires position information indicating the current position and time information (date and time of selection) representing the present time. The control unit 400 may acquire position information for the current position using a GPS or wireless-LAN receiver contained in the information processing apparatus 1, for example. The control unit 400 may also acquire time information which is information on the present time as the date and time of icon selection via a clock included in the information processing apparatus 1 or a website that provides present time information. While the present embodiment is described by taking a case where address is used as position information for the current position as an example, the embodiment is not limited thereto. For example, latitude and longitude information may be used as position information. As mentioned above, an address and latitude/longitude are pieces of information that may be translated to each other.

At step S1603, the control unit 400 registers icon information that identifies the icon 3 selected at step S1601 in selection history list 700 as selection history information 701, so that the icon information is associated with the position information and time information (date and time of selection) acquired at step S1602.

Next, at step S1604, reference is made to selection history list 700, and selection history information 701 that has date and time of selection 704 falling within a predetermined period is extracted. Then, based on the selection history information 701 extracted, information on the area and time period in which each icon 3 was selected and the number of times the icon 3 was selected is aggregated, thereby generating aggregation information 1500. The aggregation information 1500 includes icon selection aggregation information 1501 (as each entry) as mentioned above. The icon selection aggregation information 1501 is information indicating that the icon 3 identified by icon 1502 was selected the number of times indicated by frequency of selection 1505 while the information processing apparatus 1 was located in the area indicated by area 1503 during the time period indicated by time period 1504, within the predetermined period used at step S1604.

Then, at step S1605, reference is made to pieces of icon selection aggregation information 1501 (entries) registered in aggregation information 1500. It is then determined whether or not there is any icon selection aggregation information 1501 whose frequency of selection 1505 has changed to display-setting specifying information 801 corresponding to a different range of frequency of selection 803 as a result of the icon 3 being selected at step S1601. When there is no icon selection aggregation information 1501 whose display-setting specifying information 801 has changed to a different range (No at step S1605), the flow returns to step S1601. When there is icon selection aggregation information 1501 whose display-setting specifying information 801 has changed to a different range (Yes at step S1605), the flow proceeds to step S1606.

At step S1606, the control unit 400 of the information processing apparatus 1 acquires icon 1502, area 1503, and time period 1504 from the icon selection aggregation information 1501 whose display-setting specifying information 801 has changed to a different range. The icon 1502, area 1503, and time period 1504 acquired are then associated with change information 802 included in the currently corresponding display-setting specifying information 801 and registered in the setting information 1100 as icon setting information 1101. It is possible that icon setting information 1101 including the icon 1502, area 1503, and time period 1504 acquired is already registered in setting information 1100. In that case, the value of change information 1105 of the already registered icon setting information 1101 is updated to the change information 802 of the currently corresponding display-setting specifying information 801. After registration of icon setting information 1101 in setting information 1100 or update of icon setting information 1101 at step S1606, the flow returns to step S1601.

Through the operation flow of FIG. 16 described above, the setting information 1100 illustrated in FIG. 11 is generated. The operation flow of FIG. 16 aggregates the number of times icons 3 have been selected per area and time period. For an icon 3 that is frequently selected and used in the current area and time period, the control unit 400 registers icon setting information 1101 having change information 1105 that makes the icon 3 easy to select in the setting information 1100. This may generate setting information 1100 without any option for the user to decide which icons 3 he/she often uses in which area and in which time period on his/her own and manually create the setting information 1100.

In the processing performed at step S1601 of FIG. 16, the control unit 400 of the information processing apparatus 1 functions as the selection accepting unit 414, for example. In the processing performed at step S1602 to S1604, the control unit 400 of the information processing apparatus 1 functions as the selection history aggregating unit 415, for example. In the processing performed at steps S1605 to S1606, the control unit 400 of the information processing apparatus 1 functions as the generation unit 413, for example.

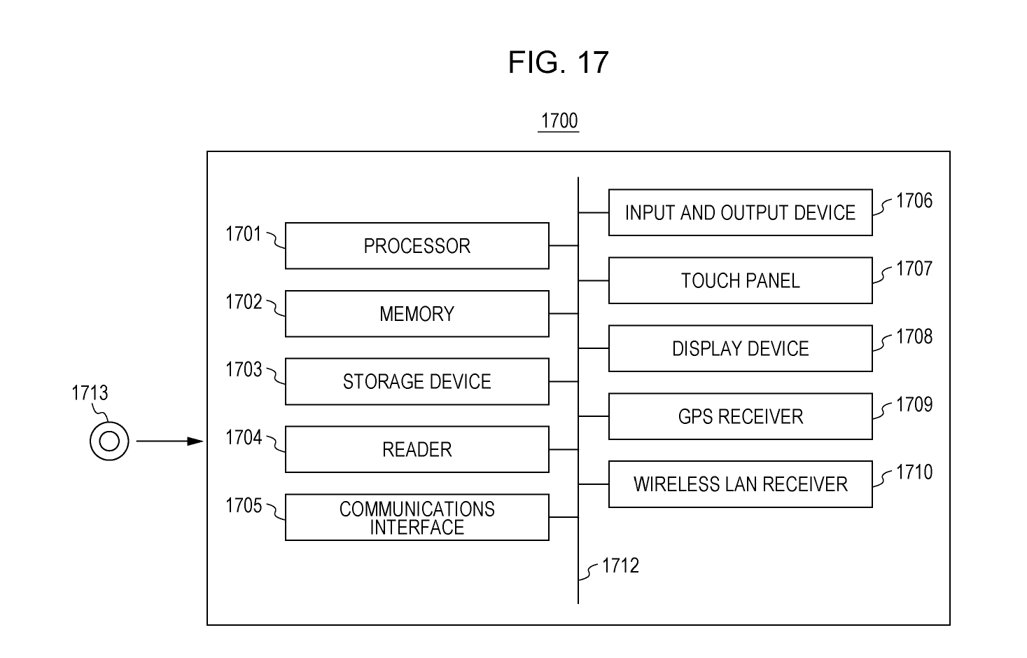

FIG. 17 is a diagram illustrating an example of a hardware configuration of an information processing apparatus, according to an embodiment. FIG. 17 illustrates an exemplary hardware configuration of a computer 1700 for realizing the information processing apparatus 1 according to embodiments. The hardware configuration of FIG. 17 for realizing the information processing apparatus 1 includes a processor 1701, a memory 1702, a storage device 1703, a reader 1704, a communications interface 1705, and an input and output device 1706. The hardware configuration of FIG. 17 for realizing the information processing apparatus 1 further includes a touch panel 1707, a display device 1708, a GPS receiver 1709, and a wireless LAN receiver 1710. These hardware components are interconnected via a bus 1712.

The processor 1701 provides functions of some or all of the functional units described above by executing the program 420 which describes the procedures of the aforementioned operational flows by utilizing the memory 1702, for example. The aforementioned control unit 400 may be the processor 1701, for example, and the storage unit 410 includes the memory 1702, storage device 1703, and a removable storage medium 1713. The processor 1701 of the information processing apparatus 1 functions as the acquisition unit 411, settings changing unit 412, generation unit 413, selection accepting unit 414, and selection history aggregating unit 415, for example, by reading and executing the program 420 stored in the storage device 1703, for example.

The storage device 1703 of the information processing apparatus 1 stores setting information 500, 1100, selection history list 700, range specifying information 800, aggregation information 1000, 1500, schedule list 1200, and schedule classification setting information 1300, for example.

The memory 1702 may be semiconductor memory, for example, and includes RAM and ROM areas. The storage device 1703 may be a hard disk, or semiconductor memory such as flash memory and solid-state drive (SSD), or an external recorder.

The reader 1704 accesses the removable storage medium 1713 responsive to instructions from the processor 1701. The removable storage medium 1713 is realized by a semiconductor device (such as a USB memory), a medium which achieves information input and output by magnetic action (such as a magnetic disk), a medium which achieves information input and output by optical action (such as a CD-ROM or DVD), or the like. The communications interface 1705 is connected with a network, for example, and transmits and receives data via the network responsive to instructions from the processor 1701. The input and output device 1706 represents an interface between an input device, such as a camera and a microphone, and an output device such as a speaker.

The touch panel 1707, which may be the touch panel 2 for example, is a device for accepting inputs made on the display screen via contact or the like, and includes resistive, capacitive, and other types of touch panel. The display device 1708 is a display, for example. The GPS receiver 1709 is a device to receive signals from GPS satellites and determine the current position. The wireless LAN receiver 1710 is a device for connecting to a wireless LAN. The processor 1701 may derive position information based on the MAC address and electric field intensity of a signal from an access point received by the wireless LAN receiver 1710, for example.

The program 420 according to embodiments may be provided to the information processing apparatus 1 in any of the following forms, for example:

(1) being preinstalled in the storage device 1703,

(2) being provided on the removable storage medium 1713, or

(3) being provided by way of the communications interface 1705 from, for example, a server distributing the program.

As described above, according to the embodiments, the operability of the information processing apparatus 1 may be improved by changing icon display settings using position information for the current position of the information processing apparatus 1.

While the above-described embodiments illustrate enlargement of icon display size as an example of emphasis of icons 3, the embodiments are not limited thereto. For example, icons 3 of interest may be emphasized by blinking their display or changing their color.

Also, in the above-described embodiments, the information processing apparatus 1 acquires a relatively detailed address, that is, down to block number, as position information for its current position. Meanwhile, addresses are registered as a relatively wide region, such as prefecture, city, or ward (“ku”), in area 503, 1103 of the setting information 500, 1100 and area 1003, 1503 of the aggregation information 1000, 1500. The unit of the region may be arbitrarily determined as appropriate for the form and environment of use, for example.

In a case where the user's office and home are within the same city and close to each other, the office and the home may not be distinguished from each other when a unit such as “city” or “prefecture” is used as area. In such a case, area 503, 1103, and area 1003, 1503 of the aggregation information 1000, 1500 may be registered in a smaller unit such as “Cho” or block number. Further, when the user wants to make different settings for a meeting room and around the user's own desk at the office, for example, it may be achieved by setting areas in a further smaller unit.

Also, while the above-described embodiments use address as position information and area, information such as latitude and longitude may be used instead. In this case, the range specified by area 503, 1103, for example, may be defined as a region within a certain radial distance from predetermined latitude and longitude.

Additionally, while the above-described embodiments describe a case where multiple pieces of display-setting specifying information 801 (entries) are registered in the range specifying information 800, the embodiments are not limited thereto. For example, a single piece of display-setting specifying information 801 may be registered as range specifying information 800. In this case, a predetermined numerical value may be registered as the range of frequency of selection 803, for example, and step S905 of FIG. 9 and step S1605 of FIG. 16 may determine whether or not an icon has been selected the number of times equal to the predetermined value or more.

While several embodiments have been described above, embodiments are not limited to the above-described embodiments and are to be construed as encompassing variations and alternatives thereof. For example, it will be understood that the embodiments may be practiced with modification to components without departing from the spirit and scope of the present disclosure. It will be also understood that combinations of components disclosed in the above-described embodiments may form various embodiments according to the present disclosure. Alternatively, it will be understood by those skilled in the art that the embodiments of the present disclosure may be practiced with deletion or replacement of some of the components set forth in the embodiments, or with addition of some components to the components set forth in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a display device configured to display an icon associated with an executable function on a display screen based on display settings including a selection recognition zone associated with the icon;
a memory configured to store icon setting information that associates the icon, an area, and change information for changing the display settings of the icon; and
a processor configured to:
determine that the icon is selected when the selection recognition zone is specified on the display screen,
acquire position information of the information processing apparatus, and
change the display settings of the icon based on the change information of the icon setting information when the position of the information processing apparatus is within the area registered in the icon setting information.

2. The information processing apparatus of claim 1,
wherein the change information is information for changing the display settings so as to enlarge the selection recognition zone.

3. The information processing apparatus of claim 1,
wherein the change information is information for changing the display settings so as to display the icon with emphasis.

4. The information processing apparatus of claim 1, wherein,
when the icon has been selected in the area a predetermined number of times or more within a predetermined period, the processor registers in the memory the icon setting information that associates the icon, the area, and the change information for changing the display settings so as to make the icon easy to select.

5. The information processing apparatus of claim 1, wherein
the icon setting information further includes information on a time period;
the processor acquires time information; and
when the position of the information processing apparatus is within the area registered in the icon setting information and the time information falls within the time period registered in the icon setting information, the processor changes the display settings of the icon based on the change information of the icon setting information.

6. The information processing apparatus of claim 1, wherein
the memory further stores:
schedule information that associates a scheduled event, the time period of the scheduled event, and classification indicating a category of the scheduled event, and
schedule classification setting information that associates the classification, the icon, and the change information for changing the display settings so as to make the icon easy to select;
the processor acquires time information;
when the position of the information processing apparatus is not within the area registered in the icon setting information, the processor references the schedule information;
when the time information falls within the time period of the scheduled event, the processor acquires the icon corresponding to the classification of the schedule information and the change information from the schedule classification setting information; and
the processor changes the display settings of the icon based on the change information acquired.

7. The information processing apparatus of claim 1, wherein
when the selection recognition zones of neighboring two icons overlap as a result of enlargement when the selection recognition zones of the neighboring two icons are enlarged based on the change information of the icon setting information, the processor gives higher priority to enlargement of the icon that has been selected more frequently in the area registered in the icon setting information within a predetermined period.

8. A computer readable recording medium having stored therein a program for causing a computer to execute a process for changing display settings of icons on a display screen of an information processing apparatus including the computer, the process comprising:
acquiring position information of the information processing apparatus;
referencing icon setting information that associates an icon associated with an executable function, an area, and change information for changing the display settings so as to make the icon easy to select; and
changing the display settings of the icon based on the change information of the icon setting information when the position of the information processing apparatus is within the area registered in the icon setting information.

9. A method for causing a computer to change display settings of icons on a display screen, the method comprising:
acquiring a position information of the computer;
referencing icon setting information that associates an icon associated with an executable function, an area, and change information for changing the display settings so as to make the icon easy to select; and
changing the display settings of the icon based on the change information of the icon setting information when the position of the computer is within the area registered in the icon setting information.
